(19) United States
(12) Patent Application Publication
(10) Pub. No.: US 2009/0106573 A1
(43) Pub. Date: Apr. 23, 2009

(54) Power saving method

(75) Inventor: Tsan-Yun Lin, Taipei (TW)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/907,856

(22) Filed: Oct. 18, 2007

(51) Int. Cl. G06F 1/32

(52) U.S. Cl. 713/324

(57) ABSTRACT

The present invention is to provide a power saving method which reduces the consumption of voltage of the notebook computer under a power saving mode. While the notebook computer enters the power saving mode, the configuration information of a south bridge chip of the notebook computer is read first, then said configuration information is stored in a non-volatile memory of the notebook computer, and then the voltage supply to the south bridge chip is cut. When the notebook computer is ordered to resume, voltage will be supplied to the south bridge chip, then the configuration information stored in the non-volatile memory will be retrieved, and then the south bridge chip will be set according to the configuration information to resume the notebook computer to the booted status.

### FIELD OF THE INVENTION

The present invention relates to a power saving method, more particularly to a method for stopping supplying voltage to a south bridge chip of a notebook computer while the notebook computer is in a power saving mode.

### BACKGROUND OF THE INVENTION

The world today enters an era of information and electronic industry. As high-tech products derived from all kinds of computers, mobile communication products and technologies of communication and network advance, high-tech products and electronic devices become more compact, multi-functional, cheap and popular as well. When making choices out of all kinds of electronic products, consumers tend to evaluate them with strict standards towards the function, appearance and size etc. Thus, whether the future electronic products are capable of providing functions and services which are more convenient, efficient and excess in quantity have become the key of taking the lead in manufacturing technology and having the attentions of the consumers.

The market of high-tech products today is the one with intense competition that computers are most welcomed among all of the high-tech products, and the prevalence of computers has brought dramatic changes to life styles of people as well as the ways of work. In the society of fast-pace nowadays, notebook computer is the most important and popular one among all kinds of portable electronic devices for its versatility and portability. Notebook computer today is powerful and capable of accessing the network wirelessly which enables user to acquire digital information without delay or engage in real time communications, therefore makes notebook computer more useful.

One of the very first issues when developing all kinds of notebook computers is to make the notebook computers last longer. Ordinary notebook computers are equipped rechargeable batteries for different occasions. When the battery is exhausted, either the rechargeable battery must be charged or an external power supply must be provided for the notebook computer to maintain operation which makes notebook computer lose its portability and the user feel disturbed as well as make the utilization of notebook computer not so convenient.

To solve the problem that the battery of the notebook computer needs to be charged frequently, all manufacturers have made some improvements constantly so the notebook computer would last longer. One of the power saving design is to enter the notebook computer a so-called standby mode after it is not in use for a period of time. Under said standby mode, the consumption of power could be reduced via shutting down certain components of the notebook computer (such as the screen and the hard disk). However, due to the south bridge chip installed in the notebook computer and the keyboard controller connected thereto are still consuming power while the notebook computer is under the standby mode, the result of said design is not sufficiently satisfying. Thus, all manufacturers are still facing the important issue of how to prevent the power of the notebook computer from wasting.

### SUMMARY OF THE INVENTION

For the purpose of solving the problems stated above that the conventional notebook computer is incapable of saving power, after hark work of research and experiments for a long time, the inventor has developed a power saving method of the present invention.

One of the objective of the present invention is to provide a power saving method which reduces the consumption of voltage of the notebook computer under a power saving mode. While the notebook computer enters the power saving mode, the configuration information of a south bridge chip of the notebook computer is read first, then said configuration information is stored in a non-volatile memory of the notebook computer, and then the voltage supply to the south bridge chip is cut. When the notebook computer is ordered to resume, voltage will be supplied to the south bridge chip, then the configuration information stored in the non-volatile memory will be retrieved, and then the south bridge chip will be set according to the configuration information to resume the notebook computer to the booted status.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 shows the structure of a notebook computer of a preferred embodiment of the present invention; and

FIG. 2 is a flow chart shows a power saving method of a preferred embodiment of the present invention.

### DETAILED DESCRIPTION OF THE PREFERRED EMBODIMENT

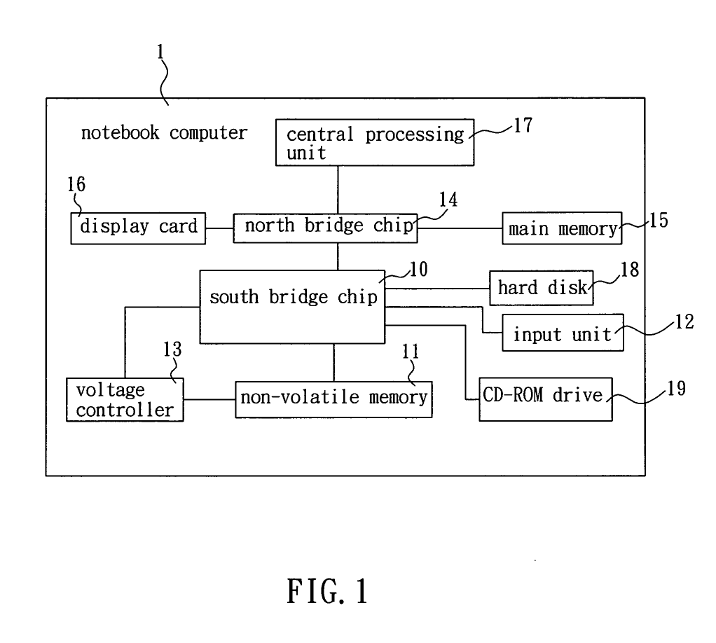

Please refer to FIG. 1, the present invention is a power saving method applied to a notebook computer 1. Upon receiving a power saving instruction under the booted status, the notebook computer 1 reads the configuration information of a south bridge chip 10 of the notebook computer 1, stores said configuration information in a non-volatile memory 11 of the notebook computer 1, and cuts the voltage supply to the south bridge chip 10 to enter a power saving mode. When the notebook computer 1 receives a resumption instruction under the power saving mode, voltage will be supplied to the south bridge chip 10, the configuration information stored in the non-volatile memory 11 will be retrieved, then the south bridge chip 10 will be set according to the configuration information to resume the notebook computer 1 to the booted status. Thus, the power saving method of the present invention is capable of substantially reducing the consumption of voltage of the notebook computer 1 under the power saving mode and makes the notebook computer 1 last longer.

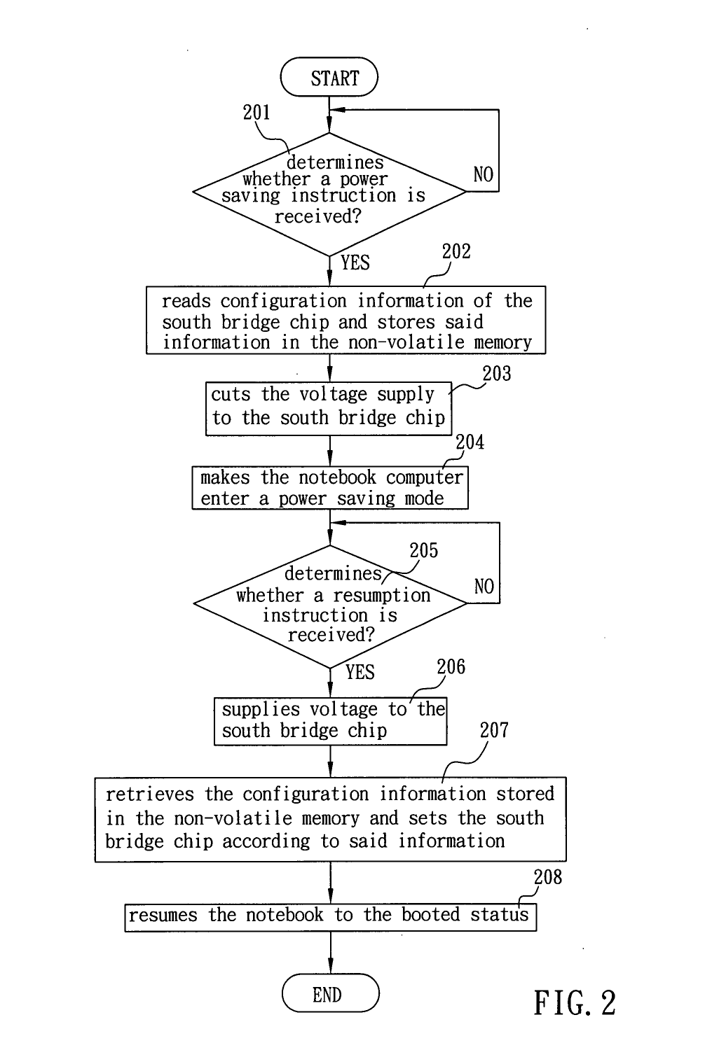

Please refer to FIG. 2, the steps of said power saving method will be illustrated in detail with a preferred embodiment of the present invention as below:

(201) determines whether a power saving instruction is received while the notebook computer 1 is under the booted status, proceeds to step (202) when affirmative, otherwise continues with step (201);

In one preferred embodiment of the present invention, the power saving instruction is produced when the notebook computer 1 hasn't received any input from an input unit 12 (such as a keyboard or mouse) of the notebook computer 1 for a predetermined period (such as five minutes) after which the notebook computer 1 should enter the power saving mode.

(202) reads the configuration information of the south bridge chip 10 and stores said configuration information in the non-volatile memory 11;

In present invention, the non-volatile memory 11 may be a complementary metal-oxide semiconductor (CMOS for short) connected with the south bridge chip 10. Furthermore, the voltage for the operation of the non-volatile memory 11 is provided by a voltage controller 13 of the notebook computer 1 connected with the south bridge chip 10. Thus, the configuration information stored in the non-volatile memory 11 won't be lost while the notebook computer 1 is shut down or the power is exhausted.

(203) cuts the voltage supply to the south bridge chip 10 to substantially reduce the consumption of voltage;

In present invention, the south bridge chip 10 is connected with a north bridge chip 14 of the notebook computer 1. According to the method of the present invention, before stopping the voltage supply to the south bridge chip 10, the programs and files currently run by the notebook computer 1 is stored in a main memory 15 (such as volatile memory etc.) connected with the north bridge chip 14 in advance, then said programs and files are closed, the voltage supply to the central processing unit 17 of the notebook computer 1 is cut, the peripheral devices (such as the display card 16 shown in FIG. 1) of the notebook computer 1 connected with the north bridge chip 14 are shut down, and finally the voltage supply to the north bridge chip 14 is cut without shutting down the main memory 15.

In present invention, in addition to the voltage controller 13 and the non-volatile memory 11, the south bridge chip 10 further connected with certain peripheral devices (such as the input unit 12, hard disk 18 and CD-ROM drive 19 etc.) of the notebook computer 1 which are shut down before the voltage supply to the south bridge chip 10 is cut.

(204) makes the notebook computer 1 enter the power saving mode;

determines whether a resumption instruction is received, proceeds to step (206) when affirmative, otherwise continues with step (205);

In present invention, the resumption instruction is produced while any signal (such as those of pressing the buttons or moving the mouse) from input unit 12 is received. Thus, the user may resume the notebook computer 1 to the booted status of when desired.

(206) supplies voltage to the south bridge chip 10;

In present invention, when supplying voltage to the south bridge chip 10, the voltage is transmitted to the south bridge chip 10 from the voltage controller 13, then transmitted to the peripheral devices connected with the south bridge chip 10 respectively.

(207) retrieves the configuration information stored in the non-volatile memory 11 and sets the south bridge chip 10 according to said configuration information to resume the south bridge chip 10 to the booted status and the peripheral devices connected with the south bridge chip 10 as well; and

(208) resumes the notebook computer 1 to the booted status.

In one preferred embodiment of the present invention, before the notebook computer 1 is fully resumed to the booted status, voltage is supplied to the north bridge chip 14, the peripheral devices connected therewith (such as the main memory 15 and display card 16 shown in FIG. 1), and the central processing unit 17, then the programs and files stored before the notebook computer 1 entering the power saving mode is retrieved from the main memory 15, and finally said programs and files are executed so as to resume the notebook computer 1 to the booted status and said programs and files as well.

As stated above, the power saving method of the present invention cuts the voltage supply to the south bridge chip 10 while the notebook computer 1 enters power saving mode, and thereby prevents the voltage from consumption by the south bridge chip 10 and the chips connected therewith (such as a keyboard controller, KBC for short) as well and substantially reduces the consumption of voltage so that the notebook computer 1 may last much longer.

While the invention herein disclosed has been described by means of specific embodiments, numerous modifications and variations could be made thereto by those skilled in the art without departing from the scope and spirit of the invention set forth in the claims.

What is claimed is:

1. A power saving method applied to a notebook computer, said notebook computer comprising a south bridge chip and a non-volatile memory, said power saving method comprising the steps of:
receiving a power saving instruction;
reading configuration information of said south bridge chip of said notebook computer and storing said configuration information in said non-volatile memory of said notebook computer;
stopping supplying voltage to said south bridge chip and said notebook computer enters a power saving mode;
receiving a power saving resumption instruction;
supplying voltage to said south bridge chip;
retrieving said configuration information stored in said non-volatile memory and setting said south bridge chip according to said configuration information; and
resuming said notebook computer to booted status.

2. A power saving method of claim 1, wherein said power saving instruction is produced while said notebook computer hasn't received any input from an input unit of said notebook computer under booted status for a predetermined period after which said notebook computer should enter the power saving mode.

3. A power saving method of claim 1, wherein said stopping step cuts voltage supply to peripheral devices of said notebook computer connected with said south bridge chip before the voltage supply to said south bridge chip is cut.

4. A power saving method of claim 3, wherein before proceeding to said stopping step, said method further comprising the steps of:
storing programs and files currently run by said notebook computer in a main memory of said notebook computer;
closing said programs and files currently run by said notebook computer;
stopping the voltage supply to a central processing unit of said notebook computer;
shutting down a display card of said notebook computer connected with a north bridge chip; and
shutting down the voltage supply to said north bridge chip without shutting down the main memory.

5. A power saving method of claim 1, wherein said resumption instruction is produced while said notebook computer is under said power saving mode and receives a signal from a input unit of said notebook computer.

6. A power saving method of claim 4, wherein voltage is transmitted from a voltage controller of said notebook computer to said south bridge chip and peripheral devices connected with said south bridge chip are resumed while voltage is supplied to said south bridge chip.

7. A power saving method of claim 6, wherein after voltage is supplied to said south bridge chip and before said notebook computer is resumed to booted status, said method further comprising the steps of:
supplying voltage to a north bridge chip, peripheral devices of said notebook computer connected with said north bridge chip and said central processing unit;
retrieving said programs and files stored before said notebook computer entered said power saving mode from said main memory; and
executing said programs and files.
